(19) United States
(12) Patent Application Publication
(10) Pub. No.: US 2005/0196231 A1
(43) Pub. Date: Sep. 8, 2005

(54) Quick-locking connector

(76) Inventors: Frederick Duguld McKay, Aberdeen (GB); Richard John Gloria, Aberdeen (GB); Corn Alexander Black, Inverurie (GB)

Correspondence Address: DOMINGUE & WADDELL, PLC, P.O. Box 3405, LAFAYETTE, LA, 70502, US

(21) Appl. No.: 11/047,461

(22) Filed: Jan. 31, 2005

(30) Foreign Application Priority Data
Mar. 3, 2004 (GB) 0404753.6
May 4, 2004 (GB) 0409894.3

(51) Int. Cl. F16L 35/00

(52) U.S. Cl. 403/364

(57) ABSTRACT

A quick-locking connector and method for use in the oil and gas industry. The quick-locking connector comprises male and female portions, which mate together in a non-coaxial hinged relationship. Rigid connection is achieved by guidance and location of spring-loaded buttons of the male portion into apertures of the female portion. The connector allows the female portion to be attached to a horizontal element, such as a horizontal drill pipe, and to mate with the male portion attached to a vertical element. In this configuration, lifting the male portion vertically upwards allows gravity to locate the spring-loaded buttons of the male portion into the female portion to provide rigid attachment at the connector such that the elements can be secured vertically inline with each other. The connector therefore provides a self lifting capability.

### FIELD OF THE INVENTION

This present invention relates to a quick-locking connector, particularly, but not exclusively for use in the gas-or-oil-recovery industry.

### BACKGROUND OF THE INVENTION

One such known connector is that described in U.S. Pat. No. 5,052,849. This quick-locking connector comprises a tubular female body member, open at one end to receive a male member therein. A latch is located within the female body member spring-urged towards the open end to engage the male member. A plurality of external, longitudinally spaced bearing surfaces are provided on the male member and complementary bearing surfaces are provided internally of the female body member such that after entry of the male member a quarter turn of the members brings the respective bearing surfaces into engagement at longitudinally spaced intervals against pressure from the latch to provide a longitudinally spaced plurality of complementary bearing surfaces to be subjected to axial impact forces tending to pull the male and female members apart. A plurality of complementary bearing surfaces may be provided to be subjected to impact forces in the opposite axial direction. The bearing surfaces of the male member are provided by at least two longitudinally spaced flange members. Apertures are provided in the female body member and latch respectively and are adapted to co-operate when the male member is locked within the body to permit entry of a lever member to provide leverage for moving the latch against its spring pressure to release the male member.

While this quick-locking connector is designed to withstand high tensile and compression forces in use, it cannot operate under torque forces. Indeed, if torque were applied between the male and female members there is a likelihood of damage to the coupling.

An additional disadvantage of the prior art coupling is that the male and female members must be axially aligned for connection. This typically requires a tool including a female member to be raised to a vertical position before connection to a vertically arranged male member can be made.

It is an object of at least one embodiment of the present this invention to provide a quick-locking connector with safe operation, high torque capability and lower manufacturing cost over prior art quick-locking connectors.

It is a further object of at least one embodiment of the present invention to provide a quick-locking connector which is selectively hinged with self-lifting capability.

### SUMMARY OF THE INVENTION

According to a first aspect of the present invention, there is provided a quick-locking connector comprising a female member having a substantially cylindrical body including a plurality of first mating portions axially arranged with respect to said body, a male member having a substantially cylindrical body including at least one second mating portion axially arranged and extending from said body, said female member including longitudinal arranged apertures between respective first mating portions into which the second mating portion is inserted and by rotation of the members with respect to each other by a first angle, the connector is locked and radially extending mating faces of the male and female members are curved in a first plane so that the members are hinged together.

Preferably the mating faces are part-circular having a common centre. In this way the members are hinged so that they may be rotated with respect to each other in one plane. The mating surfaces further provide complementary bearing surfaces which are oppositely arranged to be subjected to axial impact forces. Optionally the mating surfaces can be stepped so as to increase the mating surface area and hence increase tensile bearing ratings for the connector.

Preferably the first mating portions comprise a dual prong between which is inserted the second mating portion which comprises a spade.

Preferably the connector includes first connecting means to positively engage the second mating portion to the first mating portions. Advantageously the first connecting means is a pivotal connection such that the members are hinged so that they can be rotated with respect to each other in one plane.

The first connecting means may comprise at least one spring loaded stepped button. Preferably there are two oppositely arranged spring loaded stepped buttons located in the second mating portion which, when extended, locate in complimentary apertures in the first mating portion.

Alternatively the first connecting means may comprise a bolt or solid pin. The solid pin may comprise an internally threaded pin section and a complimentary locking screw. Such connecting means provide a fail-safe connector which prevents ingress of debris into the connector which could affect movement of the hinge.

Advantageously the connector may include second connecting means. The second connecting means may be identical to the first connecting means. When both connecting means are used, the connector may selectively be operated in a fixed linear configuration. Alternatively the second connection means may rigidly locate the mating portions at a selected angle with respect to each other.

Preferably the spring loaded stepped buttons include a rounded head. Preferably one or more channels are located in the members. The channels are arranged such that the rounded heads can locate in the channels and thus the buttons can be guided towards the apertures. In this way the quick-locking connector has a self lifting capability.

According to a second aspect of the present invention there is provided a method of lifting a horizontally arranged element into a vertical position, the method comprising the steps:
(a) locating a female member of a quick-locking connector to an end of the element;
(b) locating a male member of the quick-locking connector to an end of a vertically moveable support;
(c) positively engaging the male member with the female member in a hinged position; and
(d) lifting the male member so that the female member swings into a vertical position by gravity and thereby arranges the element in a co-linear vertical position.

Preferably the quick-locking connector is according to the first aspect.

Preferably buttons on the male member locate on the female member during the positive engagement. More preferably the buttons are guided through the female member so that the engagement can occur without human intervention. The method thus provides a self lifting capability.

Alternatively the quick-locking connector includes one or more manually operated pins which are pushed or screwed into position to provide a fail-safe arrangement.

The method may further include the step of locking the members into linear alignment when they are vertically arranged.

### BRIEF DESCRIPTION OF THE DRAWINGS

Embodiments of the present invention will now be described, by way of example only, with reference to the following drawings of which:

FIG. 1(a) is a side elevation of a quick-locking connector according to a first embodiment of the present invention in an open configuration;

FIG. 1(b) is a sectional elevation through the line A-A of the quick-locking connector of FIG. 1(a);

FIG. 2(a) is a side elevation of a quick-locking connector according to a second embodiment of the present invention in a locked configuration;

FIG. 2(b) is a sectional elevation through the line A-A of the quick-locking connector of FIG. 2(a);

FIG. 3(a) is a side elevation of a quick-locking connector according to a third embodiment of the present invention in a locked configuration;

FIG. 3(b) is a sectional elevation through the line A-A of the quick-locking connector of FIG. 3(a); and

FIG. 4 is a part cross-sectional view of a quick-locking connector according to a fourth embodiment of the present invention in a part-locked configuration.

### DETAILED DESCRIPTION OF THE DRAWINGS

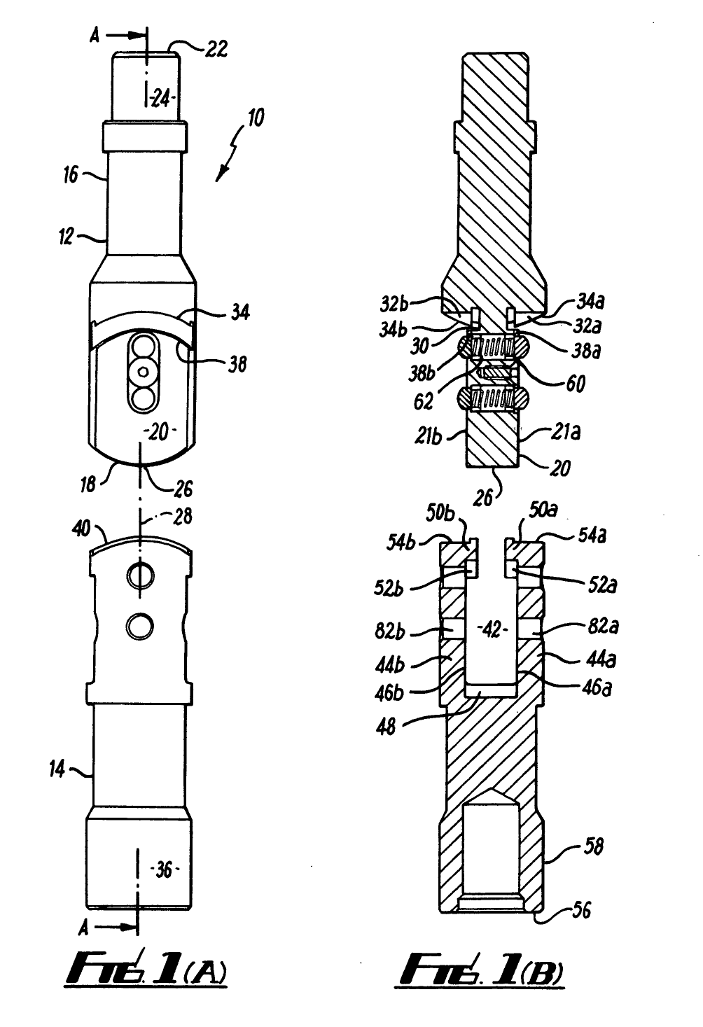

Reference is initially made to FIG. 1 of the drawings which illustrates a quick-locking connector, generally indicated by reference numeral 10, according to a first embodiment of the present invention. Connector 10 comprises two independent portions, a male member 12 and a female member 14.

Male member 12 has a solid cylindrical body 16 terminating at a first end 18 in a spade type profile 20. At its opposite end 22 there is an end piece 24 for connecting the male member 12 to a support e.g. a crane, wireline or the like. The spade type profile 20 provides an elongate extension having longitudinally arranged parallel surfaces 21a,b. The first end 18 provides a forward face 26 which is rounded over a central axis 28 of the connector 10 in a first plane. As illustrated in FIG. 1(b) the face 26 is perpendicular to the central axis in a second, orthogonal plane. The face 26 describes an arc. At a rear end 30 of the spade type profile 20 are two oppositely arranged steps 32a,b formed between the body 16 and the spade type profile 20. Steps 32a,b provide opposite mating faces 34a,b. The faces 34a,b describe arcs arranged in the first plane. Faces 34a,b are opposite to face 26 and both originate from a common centre. At the rear end 30 are also arranged two back surfaces 38a,b which face the surfaces 34a,b. Surfaces 38a,b form part of the spade type profile 20.

Female member 14 has a solid cylindrical body 36. At a first end 40 is arranged a slot 42 running longitudinally along the central axis 28. Slot 42 results in a dual prong arrangement at the first end 40, providing two semi-cylindrical portions 44a,b with parallel surfaces 46a,b bounding the slot 42. Slot 42 is terminated by a back face 48. Face 48 is perpendicular to the central axis in the second plane. At the end 40 are arranged projections 50a,b from the surfaces 46a,b. The projections 50a,b reduce the width of the slot 42 in the second plane. A back surface 52a,b of each projection 50a,b is directed towards the back face 48, while the fronts form faces 54a,b on the front end 40. Surfaces 52a,b and faces 48, 54a,b are rounded, each describing an arc from a common centre located within the slot 42, on the first plane. At an opposite end 56 of the member 14 is arranged a connecting section 58 for attaching a tool or other part to the connector 10. Known connecting types can be used.

In use, each member 12,14 is attached to a respective support and tool. The male member 12 is brought to the female member 14 and the connector 10 is assembled by inserting the male member 12 into the female member 14. This is achieved by sliding the spade profile 20 into the slot 42 horizontally on the second plane, with face 26 being aligned with the surface 48 during insertion. The spade profile 20 can be inserted from either side of the slot 42 in the female member. When the spade profile 20 is within the slot 42 the members 12,14 are rotated relative to each other by 90 degrees around the central axis 28.

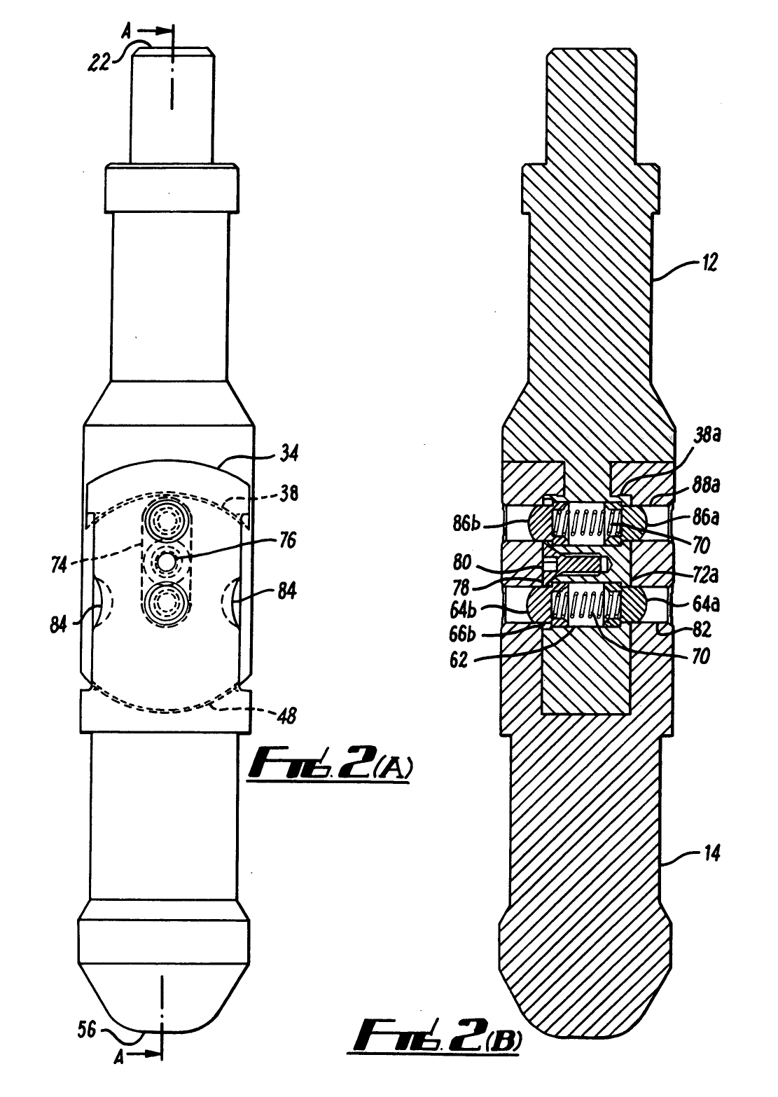

Reference is now made to FIG. 2 of the drawings which illustrates an assembled quick-locking connector 10. Like parts to those of the connector 10 of FIG. 1 have been given the same reference numeral to aid interpretation. On make-up, face 26 and surface 48 now abut as they have the same curvature and match in dimensions. Similarly, faces 34a,b meet faces 54a,b and abut on the same curvature. Projections 50a,b are held by virtue of the back surfaces 38a,b abutting the faces 52a,b. In this way the members 12,14 are effectively locked together in an ‘L’ type configuration.

In use, with the connector 10 vertical and the male member 12 upper most, heavy upward impact forces, which tend to pull the male and female members 12,14 apart, cause a reaction on radial/angled bearing surfaces 38a,b. With the maximized surface area created by the curvature, loading is distributed evenly and as a result of which the connector 10 is capable of withstanding very heavy impacts. Downward impact forces are dissipated through bearing faces 34,48 in unity. This allows the connector to endure massive compressive forces.

Additionally the connector 10 can be manipulated into a hinge. If ends 22, 56 are brought together on the first plane, the connector will bend as the male and female members 12,14 rotate about the common centre of the arcs. The connector 10 can be rotated in opposite directions. The hinge then provides over 300 degrees of positioning and consequently the connector can withstand torque forces.

Further the surfaces 38a,b provide a back angle. While this is optional in the connector 10, when present, if the connector 10 is in tension, the back angle would effectively pull the prongs together, preventing the potential of the prongs 44a,b splaying outwards.

FIGS. 1 and 2 provide an additional feature to the connector 10 in the form of stepped buttons 60, found in a further embodiment of the present invention. Through the spade profile 20 of the male member 12, between the surfaces 21a,b is located a countersunk aperture 62. Located within aperture 62 are two oppositely facing buttons 64a,b. Each button 64 has a rounded head and a flat base 66a,b. The base 66a,b provides a lip 68a,b which is used to limit movement of the button 64a,b radially outwards from the aperture 62. The buttons 64a,b are biased radially outwards by virtue of a compression spring 70 arranged between the bases 66a,b. The lips 68a,b engage with ledges 72a,b provided at each end of the aperture 62. For construction, a recess 74 and a tapped hole 76 are provided in the spade profile 20 to fit a button retaining plate 78, in turn to be retained with a screwed retaining device 80. The buttons 64a,b are thus spring loaded.

Matching apertures 82a,b are located through each of the cylindrical portions 44a,b of the female member 14. Guide ramps 84 are located on the surfaces 46a,b in order to assist entry of the buttons 64a,b into the slot 42 and come to rest in the apertures 82.

In use, as the male and female members 12,14 are brought together and the spade portion 20 is inserted in the slot 42, the buttons 64a,b are compressed via guide ramps 84 on the female member 14. They then simply pop into the corresponding apertures 82a,b as they pass them when the members 12,14 are rotated by 90 degrees. The inclusion of buttons 64a,b benefit the connection as it positively locates the profile 20 centrally allowing for easier rotation. These buttons 64a,b can also be utilised as lifting devices. If the female member 14 is lying horizontally on the ground, the male member 12 can be lowered vertically into the female member 14 until the buttons 64a,b engage in the apertures 82a,b. By then applying an upward motion to the male member 12 the buttons 64a,b will lift the female member 14 and allow gravity to swing the connector 10 into place. In this way tools and other devices can be lifted from a horizontal to vertical position.

A yet further feature which can be added to the connector 10 is the incorporation of a second set of spring loaded buttons 86a,b. The second buttons 86a,b are identical to the first set 64a,b and are mounted in an identical manner but displaced along the central axis by a short distance. Preferably the button retaining plate 78 also holds these buttons 86a,b in position. The second set of buttons 86a,b benefits the connection as it positively locks the connection to remove the pivoting action that is available without it.

In use, the first buttons 64a,b will allow the connector to be hinged to raise a the female member from an angle such as horizontally to the vertical. On reaching the vertical the second buttons 86a,b will align with second apertures 88a,b and thereby locate therein. This effectively locks the connector in a linear rigid arrangement. If it is desired to release the male member 12 from the female member 14, both buttons 86a,b are pushed together. Whilst both buttons 86a,b are together, a rotational cocking action is required through 90 degrees. With the components in the 90° position, buttons 64a,b are then pushed together and (whilst both buttons 86a,b are together), the male or female member 12,14 is removed in a 90 degree direction away from the opposing member 14,12.

The connector 10 can be used for heavy lifting applications where a long body can be lying at 90 degrees to the opposing member. By using a crane to lower the male member 12 into the other member 14, the first buttons 64a,b can engage to make the connection. Following an upward lifting action, the buttons 64a,b can be utilized as a lifting device using gravity to automatically rotate the connector 10 together. The second set of buttons 86a,b can then engage to lock the connector and form a rigid connection. This prevents any manual handling risks.

A simple spring loaded device can be used to depress buttons 64,86 for release. By using such a device, hands can be away from the connector during disassembly, again preventing many safety issues.

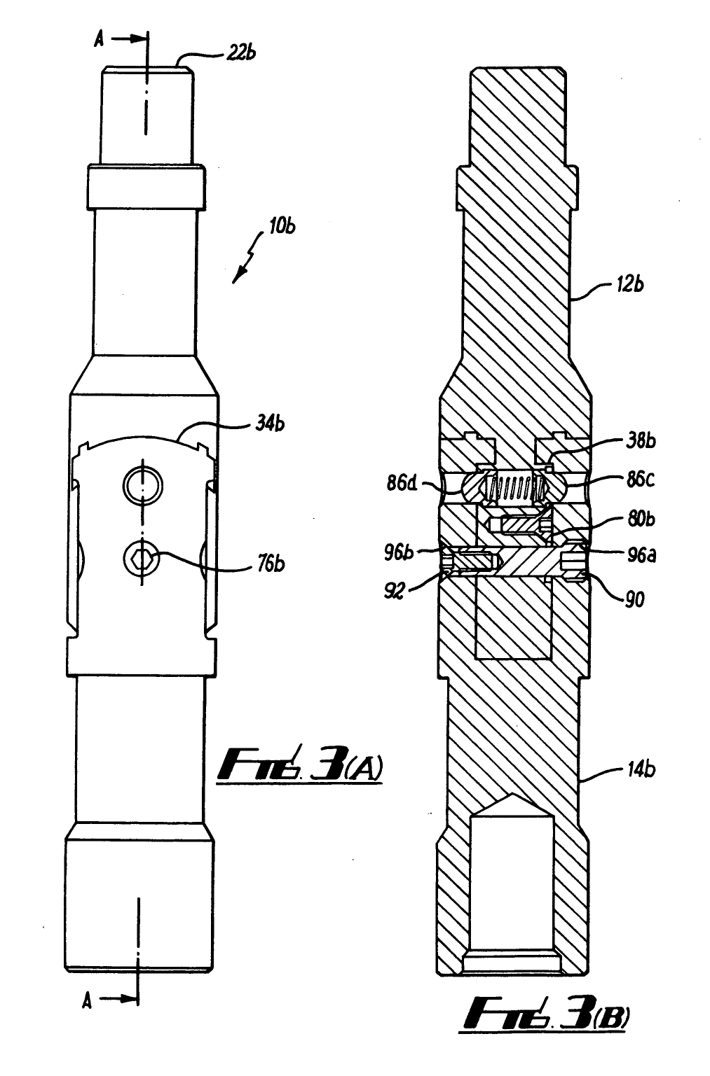

Reference is now made to FIG. 3 of the drawings which illustrates a quick-locking connector, generally indicated by reference numeral 10b, according to a third embodiment of the present invention. Like parts to those of FIG. 2 have been given the same reference numeral but are now suffixed ‘b’. It will be noted that the connectors 10a and 10b are substantially identical, excepting the replacement of buttons 64a,b. In their place is arranged a solid pin 90 and a corresponding locking screw 92. Pin 90 includes a threaded recess 94 to accept the locking screw 92. Both pin 90 and screw 92 abut oppositely arranged countersunk surfaces 96a,b. The surfaces 96a,b and the fact that the pin fills the bore prevents the ingress of dirt into the hinge area. Such a pin 90 and screw 92 arrangement provides a manually set hinge which, while not allowing hands-free setting provides a hinge which is fail-safe for heavier lifting needs and also prevents the ingress of debris which could affect the operation of the buttons 64a,b.

In use, connector 10b is assembled in a similar manner to connector 10a. When the parts 12b,14b are rotated they are locked together by the tightening of the pin 90 against the screw 92. The connector 10b then operates in an identical manner to the earlier embodiments. Lifting the connector 10b will automatically lock the connector 10b in the vertical position by virtue of the buttons 86c,d mating in the respective apertures, as described hereinbefore with reference to FIGS. 1 and 2.

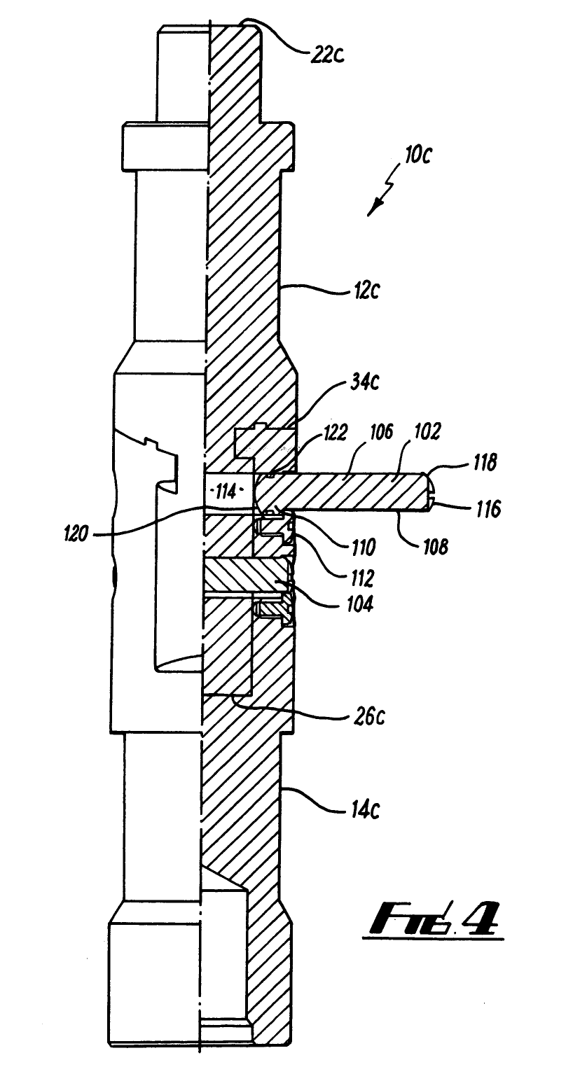

Reference is now made to FIG. 4 of the drawings which illustrates a quick-locking connector, generally indicated by reference numeral 10c, according to a fourth embodiment of the present invention. Like parts to those of FIG. 2 have been given the same reference numeral but are now suffixed ‘b’. It will be noted that the connectors 10a and 10b are substantially identical, excepting the replacement of buttons 64a,b and 86a,b.

Buttons 64a,b and 86a,b have been replaced with pins 102, 104 respectively. Each pin 102,104 is identical both in size and functionality. Each pin 102,104 comprises a substantially cylindrical body 106 having a portion removed along a side thereof 108. Removal of the portion provides a cylindrical head 110 which is trapped within the female member 14c by virtue of a cap screw 112 which overhangs the bore 114, created when the members 12c,14c are rotated by 90 degrees. The head 110 is sized to remain in the female member 14c during rotation so that it does not obstruct insertion of the male member 12c, or rotation of the coupling. Once rotation has occurred the pin 104 can be manually pushed through the bore 114 to provide a hinge. On lifting the connector 10c, pin 112 can be similarly operated to lock the connector 10c in a vertical arrangement. Thus the pins 102,104 are permanently secured to the connector 10b.

When inserted the pins 102,104 can be locked in the connector 10c by turning a screw head 116 on a respective end thereof. This causes a ledge 118 to locate below the cap screw 112. Alternatively or additionally a lower end 120 of the pin may include a circumferential recess 122 which snap-fits into a ledge on an inner surface of the bore 114.

The use of pins 102,104 provides the fail-safe and prevention of debris features of the pin and locking screw connection arrangements of FIG. 3, while also removing the need to have loose parts i.e. the pin and the screw, which could be lost or damaged prior to use.

It will be appreciated by those skilled in the art that any of the connection types can be used either solely or in combination within the connector disclosed.

The principle advantage of the present invention is that it provides a quick-locking connector which, by the use of circular symbiotic profiled members, efficiently disperses high, opposing rotational, tensional and compressive forces on the connector.

A yet further advantage of at least one embodiment of the present invention is that it provides a quick-locking connector which can be used as a hinge/elbow joint.

Other advantages of embodiments of the present invention are minimal play; a very simplistic design; less parts than prior art connectors of this type; a high tensile rating with a maximum compression rating; impossible to be prematurely released through heavy jarring inertia loads; has a high torque though potential; and it can be machined at a fraction of the cost of existing connections.

Additionally the simple design allows modern casting techniques as a manufacturing option with processes i.e investment casting.

The quick-locking connector of at least one embodiment of the present invention has further safety advantages in that the connector needs to be rotated through a full 90 degrees to be disconnected; a simple 90 degree rotation is required for installation, allowing the connection to be made with no manual handling; the buttons can be used to initially lift the component; and if connector is parted, all pieces are retained.

Alternative safety features are provided in at least one embodiment of the present invention, wherein either one or both of the button connections can be replaced with a fixed pin arrangement. Such an arrangement provides a fail-safe connection so that dirt and debris cannot enter the connection and prevent its operation.

Various modifications may be made to the invention herein described without departing from the scope thereof. For example, although a single stepped internal radial bearing surface has been described, multi stepped profiles could be used to increase tensile bearing ratings. Additionally, though the second buttons are arranged to provide a linear rigid connection between the male and female members, the buttons could be positioned off the central axis to rigidly couple the members at any chosen angle. The connector is fully adaptable as a cheap, simple hinged connector, a positively fixed hinged connector with self lifting capability, to a positively fixed non-hinged connector with self lifting capability.

1. A quick-locking connector comprising a female member having a substantially cylindrical body including a plurality of first mating portions axially arranged with respect to said body, a male member having a substantially cylindrical body including at least one second mating portion axially arranged and extending from said body, said female member including longitudinal arranged apertures between respective first mating portions into which the second mating portion is inserted and by rotation of the members with respect to each other by a first angle, the connector is locked and radially extending mating faces of the male and female members are curved in a first plane so that the members are hinged together.

2. A quick-locking connector as claimed in claim 1, wherein the mating faces are part circular having a common centre.

3. A quick-locking connector as claimed in claim 1, wherein the mating surfaces are stepped so as to increase the mating surface area.

4. A quick-locking connector as claimed in claim 1, wherein the first mating portions comprise a dual prong between which is inserted the second mating portion which comprises a spade.

5. A quick-locking connector as claimed in claim 1, wherein the connector includes first connecting means to positively engage the second mating portion to the first mating portion.

6. A quick-locking connector as claimed in claim 5, wherein the first connecting means is a pivotal connection such that the members are hinged so that they can be rotated with respect to each other in one plane.

7. A quick-locking connector as claimed in claim 5, wherein the first connecting means comprise at least one spring loaded stepped button.

8. A quick-locking connector as claimed in claim 7, wherein there are two oppositely arranged spring loaded stepped buttons located in the second mating portion which, when extended, locate in complimentary apertures in the first mating portion.

9. A quick-locking connector as claimed in claim 5, wherein the first connecting means further comprises a solid pin.

10. A quick-locking connector as claimed in claim 9, wherein the solid pin comprises an internally threaded pin section and a complimentary locking screw.

11. A quick-locking connector as claimed in claim 5, wherein the connector includes second connecting means.

12. A quick-locking connector as claimed in claim 11, wherein the second connecting means is identical to the first connecting means.

13. A quick-locking connector as claimed in claim 11, wherein the connector is selectively operated in a fixed linear configuration.

14. A quick-locking connector as claimed in claim 11, wherein the second connection means rigidly locate the mating portions at a selective angle with respect to each other.

15. A quick-locking connector as claimed in claim 7, wherein the spring loaded stepped buttons include a rounded head, each head locating in at least one channel located in a member such that the buttons can be guided towards the apertures.

16. A method of lifting a horizontally arranged element into a vertical position, the method comprising the steps of:
a) locating a female member of a quick-locking connector to an end of the element;
b) locating a male member of the quick-locking connector to an end of a vertically moveable support;
c) positively engaging the male member with the female member in a hinged position; and
d) lifting the male member so that the female member swings into a vertical position by gravity and thereby arranges the element in a co-linear vertical position.

17. A method of lifting a horizontally arranged element into a vertical position as claimed in claim 16, wherein the quick-locking connector is as claimed in claim 1.

18. A method of lifting a horizontally arranged element into a vertical position as claimed in claim 16, wherein at least one button on the male member locates on the female member during the positive engagement.

19. A method of lifting a horizontally arranged element into a vertical position as claimed in claim 18, wherein the at least one button is guided across the female member so that the engagement can occur without human intervention to provide a self lifting capability.

20. A method of lifting a horizontally arranged element into a vertical position as claimed in claim 16, wherein the method includes the further step of locking the members into linear alignment when they are vertically arranged.
